(19) United States
(12) Patent Application Publication
(10) Pub. No.: US 2026/0336287 A1
(43) Pub. Date: Oct. 29, 2026

(54) INKJET CHIP STRUCTURE

(71) Applicant: Microjet Technology Co., Ltd., Hsinchu (TW)

(72) Inventors: Hao-Jan Mou, Hsinchu (TW); Chi-Feng Huang, Hsinchu (TW); Yung-Lung Han, Hsinchu (TW); Chun-Yi Kuo, Hsinchu (TW); Ming-Yi Chou, Hsinchu (TW); Pang-Che Hsu, Hsinchu (TW); Yu-Hsin Lai, Hsinchu (TW); Chia-Yu Chu, Hsinchu (TW)

(73) Assignee: Microjet Technology Co., Ltd., Hsinchu (TW)

(21) Appl. No.: 19/190,367

(22) Filed: Apr. 25, 2025

(51) Int. Cl. B41J 2/14

(52) U.S. Cl. CPC B41J 2/14129; B41J 2/1433

(57) ABSTRACT

The present disclosure provides an inkjet chip structure. The inkjet chip structure includes an inkjet chip and plural heaters. The inkjet chip includes a first surface, a second surface, an ink supply hole and plural nozzle apertures. The ink supply hole includes a first hollow portion and a second hollow portion. The second hollow portion is concavely recessed from a bottom surface of the first hollow portion, penetrates through the second surface, and includes at least one connection rib. The connection rib is disposed transversely between two lateral walls of the second hollow portion to divide the second hollow portion to form more than two through holes. The heaters arranged in each axis array provide ink droplets of different colors. There are at least 2000 heaters to 3000 heaters arranged in the array along three longitudinal axes.

### FIELD OF THE INVENTION

The present disclosure relates to an inkjet chip structure, and more particularly to an inkjet chip structure applicable to an inkjet head on an ink cartridge.

### BACKGROUND OF THE INVENTION

In addition to a laser printer, an inkjet printer is another model that is commonly and widely used in the current market of the printers. The inkjet printer has the advantages of low price, easy to operate and low noise. Moreover, the inkjet printer is capable of printing on various printing media, such as paper and photo paper. The printing quality of an inkjet printer mainly depends on the design factors of an ink cartridge. In particular, the design factor of an inkjet chip releasing ink droplets to the printing medium is regarded as an important consideration in the design factors of the ink cartridge.

Inkjet printing technology, often referred to as “Inkjet Printing”, is a widely used printing technology. The history of inkjet printing with its origins tracking back to the 1950s when the British component of HP (Hewlett-Packard) invented inkjet printing technology. Since then, the inkjet printing technology has developed rapidly, and the inkjet printers have become the mainstream technology for home and commercial printing. The inkjet printers have many advantages, such as the cost-effectiveness, especially for home and small business use. Also, the inkjet printers have high printing quality, and can provide high-resolution and high-quality images, especially in photos or pictures. Furthermore, the inkjet printers are convenient to use and easy to install, most of inkjet printers can print through computers or mobile devices. In addition, the combination of the inkjet printers and a business machines with all-in-one functions (including fax, photocopying, and scanning) that have emerged in recent years can quickly expand the flexibility of paperwork in the office.

Please refer to FIG. 1A and FIG. 1B, which illustrate the matching and controlling method between the ink cartridge 1 and the printer according to the prior art. As shown in FIG. 1A, the ink cartridge 1 includes a flexible circuit board 10. The flexible circuit board 10 includes an inkjet head 20, and the inkjet head 20 is provided with an inkjet chip 100A. A long ink supply hole 110A is disposed at the center of the inkjet chip 100A and a plurality of nozzle apertures 120A are disposed on both sides thereof, so that the inkjet chip 100A is bilaterally symmetrical, and a plurality of circuit board contacts (not shown) are disposed and corresponding to the inkjet chip 100A and used to transmit printer control signals. The inkjet chip 100A is configured to store information, such as the ink cartridge serial number, ink type and inkjet head-printer matching information, and simultaneously control the ejection of ink droplets from the nozzle apertures 120A for printing.

The inkjet chip 100A is long and the long ink supply hole 110A runs through most of the length, so that the left side and the right side of the inkjet chip 100A only form extended continuous portions at the upper side and the lower side. Since the ink supply hole 110A runs through the top surface and the bottom surface, the structure is hollowed out in the center and cannot be continuous. In that, the stress conduction path is blocked and the stress-bearing volume is reduced. It results in insufficient support force. Since the stress is concentrated on the extended continuous portions of the inkjet chip 100A on the upper side and the lower side of the long ink supply hole 110A to generate strain, the inkjet chip 100A is prone to breakage during the production process, so as to reduce the yield.

Usually, the ink cartridge is installed inside the inkjet printer and moved laterally above the inkjet medium by a carrying system, so that the inkjet head of the ink cartridge can move to the correct position to spray the ink according to the pattern to be printed. The inkjet chip is installed on the inkjet head. That is, the carrying system drives the inkjet head and the inkjet medium to move relative to each other along a scanning axis. The scanning axis is parallel to the width of the inkjet media. Moreover, one single scanning of the driving component means that the carrying system drives the inkjet head to move once approximately over the entire width of the inkjet medium. However, between two individual times of scanning, the inkjet media is moved relative to the inkjet head along a feed axis perpendicular to the scanning axis, i.e., in the direction of the length of the inkjet media.

When the inkjet head moves along the scanning axis, a discontinuous strip is produced. All the discontinuous strips are combined to form the text or image of the printed pattern. The printing resolution along the feed axis of the inkjet media is referred to as the density of discontinuous strips along the feed axis of the inkjet media. Therefore, the greater the density of discontinuous strips on the feed axis of the inkjet media, the higher printing resolution along the axis.

As mentioned above, although the current inkjet printing technology can meet the various output needs of schools, office documents, 3D printing, and industry, the current consumer market's demands for various printing performances, such as color, resolution, printing range, and printing speed, in inkjet printing are increasingly stringent. In the current situation of general industry, there are still great demands for the above-mentioned inkjet printing performances to maintain the competitiveness of industrial utilization. Therefore, according to the current market situation, there is still an urgent need to continuously improve and optimize the performances such as printing speed and ink supply speed. In view of this, the above-mentioned demands become the subject that the present disclosure intends to explore.

### SUMMARY OF THE INVENTION

It is an object of the present disclosure to provide an inkjet chip structure. By adding at least one connection rib to the second hollow portion of the ink supply hole of the inkjet chip structure, the stress-bearing volume and the supporting force around the ink supply hole are increased, thereby improving the chip strength. The detailed technical features are described hereafter.

In accordance with an aspect of the present disclosure, an inkjet chip structure is provided and includes an ink supply hole, a first hollow portion, a second hollow portion and a plurality of nozzle apertures, wherein the ink supply hole is concavely formed on the first surface of the inkjet chip, penetrates through the second surface, and extended longitudinally. The second hollow portion is concavely recessed from a bottom surface of the first hollow portion and penetrating through the second surface. At least one connection rib is disposed and extended transversely between two lateral walls of the second hollow portion, and the second hollow portion is divided by the at least one connection rib to form more than two through holes.

In the inkjet chip structure according to an embodiment of the present disclosure, each adjacent two of the plurality of through holes on the second surface of the inkjet chip have a spaced distance greater than 30 μm. Each longitudinally adjacent two of the plurality of nozzle apertures have a vertical distance ranged from 80 μm to 90 μm, or from 40 μm to 45 μm

In the inkjet chip structure according to an embodiment of the present disclosure, the plurality of nozzle apertures longitudinally arranged have an arrangement distance ranged from 24000 μm to 26000 μm.

In an embodiment, the inkjet chip includes a chip substrate, a thermal barrier layer, a heating resistance layer, a conductive layer, a protective layer, a barrier layer, and a nozzle plate, which are stacked sequentially to form a heater structure, wherein an ink chamber is formed between the protective layer and the barrier layer, and a plurality of nozzle apertures penetrate the nozzle plate arranged on a top of the ink chamber.

The inkjet chip structure of the present disclosure can also achieve high speed printing with high resolution. At the same time, the cost is reduced by effectively utilizing the inkjet head space, and lightweight and inexpensive components are provided to achieve high performance printing. The inkjet head structure of the present disclosure is used to achieve high resolution and high speed printing by increasing the number of heaters and misaligning different groups of heaters, so that the heaters can work at high frequency.

In accordance with an aspect of the present disclosure, an inkjet chip structure in the present disclosure is used for inkjet printing of monochrome ink. The inkjet chip structure includes an inkjet chip and a plurality of heaters. The heaters are arranged in an array along three longitudinal axes. It is characterized in that the heaters arranged in the array along each longitudinal axis provides ink droplets of different colors respectively, and all of the heaters are arranged on the inkjet chip at a density of more than 25 heaters per square millimeter (mm²).

### BRIEF DESCRIPTION OF THE DRAWING

The following detailed descriptions of the present disclosure and the schematic diagrams of the embodiments should enable the present disclosure to be more fully understood. However, it should be understood that this is only used as a reference for understanding the application of the present disclosure, rather than limiting the present disclosure to a specific embodiment.

FIG. 1A is a schematic diagram illustrating a conventional ink cartridge with an inkjet chip disposed thereon according to the prior art;

FIG. 1B is a schematic diagram illustrating the conventional inkjet chip includes nozzle apertures and an ink supply hole according to the prior art;

FIG. 2A illustrates a detailed structure of an inkjet chip structure according to a first embodiment of the present disclosure;

FIG. 2B shows a further magnified detailed structure of the inkjet chip structure according the first embodiment of the present disclosure;

FIG. 3A illustrates a detailed structure of an inkjet chip structure according to a second embodiment of the present disclosure;

FIG. 3B is a cross-sectional structure showing the detailed structure of the inkjet chip structure and taken along the A-A line in FIG. 3A;

FIG. 3C is a cross-sectional view showing the detailed structure of the inkjet chip structure and taken along the B-B line in FIG. 3A;

FIG. 3D is a cross-sectional view showing the detailed structure of the inkjet chip structure and taken long the C-C line in FIG. 3A;

FIG. 4 is a top view showing a detailed structure of an inkjet chip structure according to a third embodiment of the present disclosure;

FIG. 5 is a diagram showing the detailed structure of the inkjet chip structure and taken from another three-dimensional perspective;

FIG. 6 is a cross-sectional structure showing the stacking form of the inkjet chip structure of FIG. 2A;

FIG. 7 shows a detailed structure of a control module for controlling inkjet printing of nozzle apertures according to another embodiment of the present disclosure;

FIG. 8A is a schematic diagram illustrating an inkjet chip structure according to a fourth embodiment of the present disclosure; and

FIG. 8B is a schematic diagram illustrating the inkjet chip structure after the nozzle plate is removed in FIG. 8A.

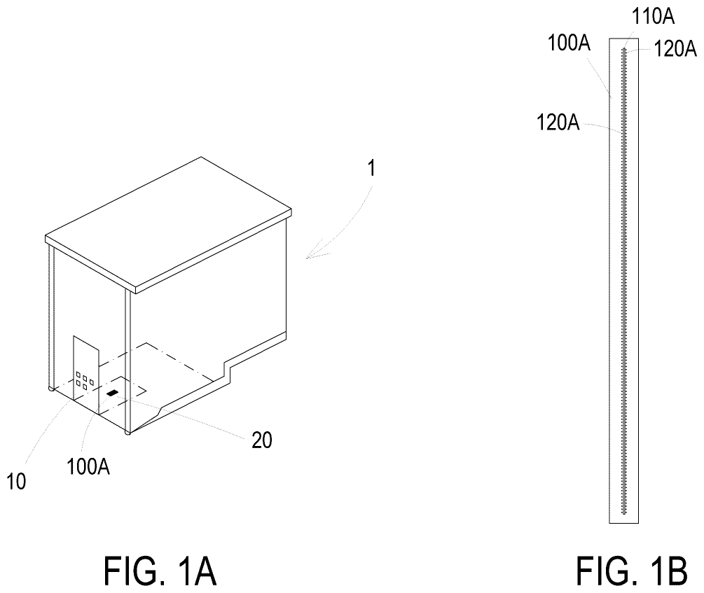

### DETAILED DESCRIPTION OF THE PREFERRED EMBODIMENT

The present disclosure will be described in detail with preferred embodiments and viewpoints. The following descriptions provide the specific implementation details of the present disclosure, so that how these embodiments are implemented can be fully understood. One skilled in the art will appreciate that the present disclosure may be practiced without these specific details. In addition, the present disclosure may also be used and implemented through other specific embodiments. The details described in the specification may also be applied based on different needs, and various modifications or changes may be made without departing from the spirit of the present disclosure. Therefore, the present disclosure will now be described more specifically with reference to the following embodiments. It is to be noted that the following descriptions of preferred embodiments of this invention are presented herein for purpose of illustration and description only. It is not intended to be exhaustive or limited to the precise embodiments disclosed. The terminology used in the following descriptions is to be interpreted in the broadest reasonable manner to enable it to be used in conjunction with the detailed description of a particular embodiment of the present disclosure. In addition, when describing the directions such as up, down, left, light, longitudinal and transverse in the present disclosure, unless otherwise defined in the specification, the relative directions of up, down, left, light, longitudinal and transverse, can be understood based on the description and the accompanying drawings and context. In that, those skilled in the art can easily understand the relevant description after reading the descriptions of the present disclosure and comparing it with the corresponding drawings, which is explained here in advance.

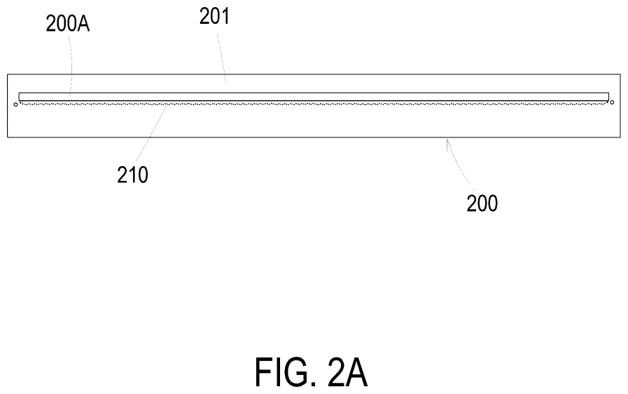

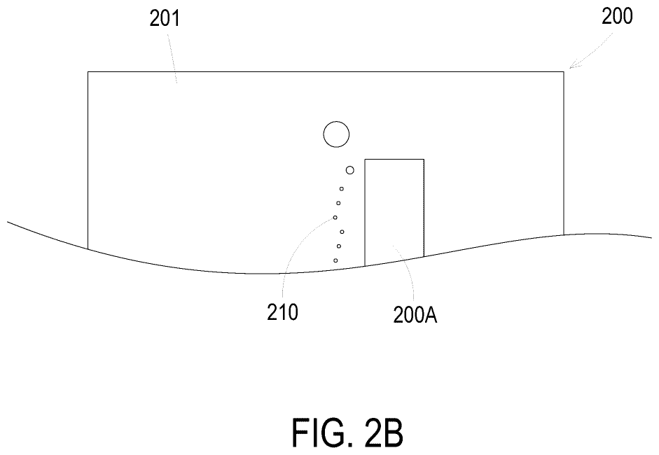

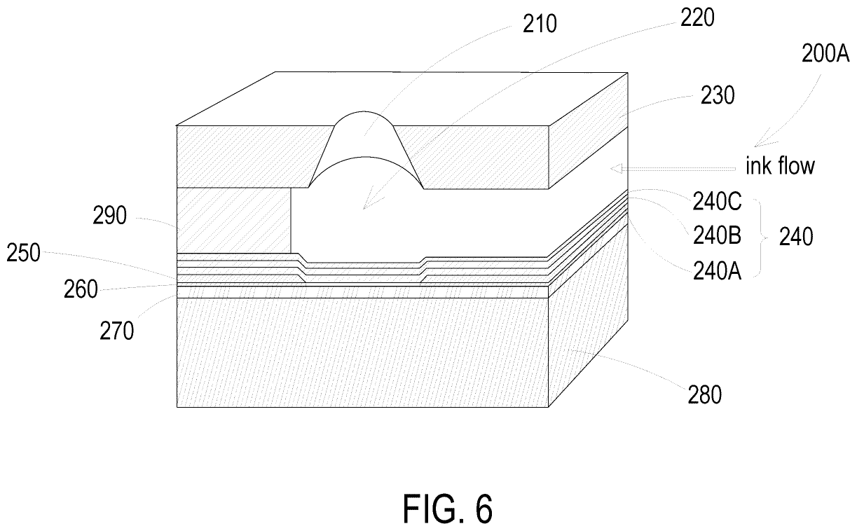

Please refer to FIG. 2A, FIG. 2B and FIG. 6. In an embodiment of the present disclosure, in order to achieve the above-mentioned purpose of improving printing performances, an inkjet chip structure is provided and includes an inkjet chip 200. The inkjet chip 200 includes a plurality of heaters 205. In the embodiment, a chip substrate 280, a thermal barrier layer 270, a heating resistance layer 260, a conductive layer 250, a protective layer 240, a barrier layer 290 and a nozzle plate 230 are stacked in sequence to form a heater 205. The chip substrate 280 is a base element. The heating resistance layer 260 is used for heating an ink, and the conductive layer 250 is configured to supply required energy to the heating resistance layer 260 to heat the ink. An ink chamber 220 is formed between the protective layer 240, the barrier layer 290 and the nozzle plate 230. A plurality of nozzle apertures 210 penetrate the nozzle plate 230 arranged on a top of the ink chamber 220. When the heating resistance layer 260 is heated, bubbles are generated in the ink chamber 220, which in turn squeezes the ink so that the ink is ejected from the nozzle apertures 210. In the embodiment, the inkjet chip 200 includes a first surface 201 and a second surface 202 opposite to each other. An ink supply hole 200A is concavely formed on the first surface 201 of the inkjet chip 200, penetrating through the second surface 202, and extended longitudinally. Preferably but not exclusively, the nozzle apertures 210 of the plurality of heaters 205 are located on one side or both sides of the ink supply hole 200A. In an embodiment, the nozzle apertures 210 of the plurality of heaters 205 form one single-row-nozzle structure as shown in FIG. 2A on the first surface 201 of the inkjet chip 200. In other embodiments, the nozzle apertures 210 of the plurality of heaters 205 are arranged regularly or irregularly in a wavy arrangement or a zigzag arrangement. In the single-row-nozzle structure according to an embodiment of the present disclosure, each longitudinally adjacent two of the plurality of nozzle apertures 210 have a vertical distance ranged from 80 μm to 90 μm.

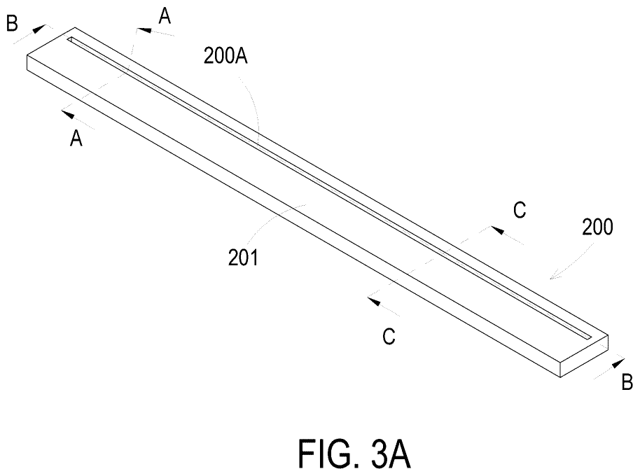

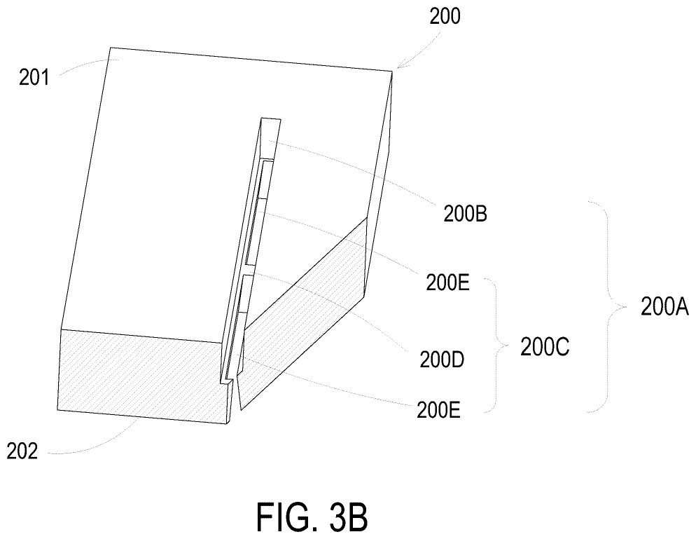

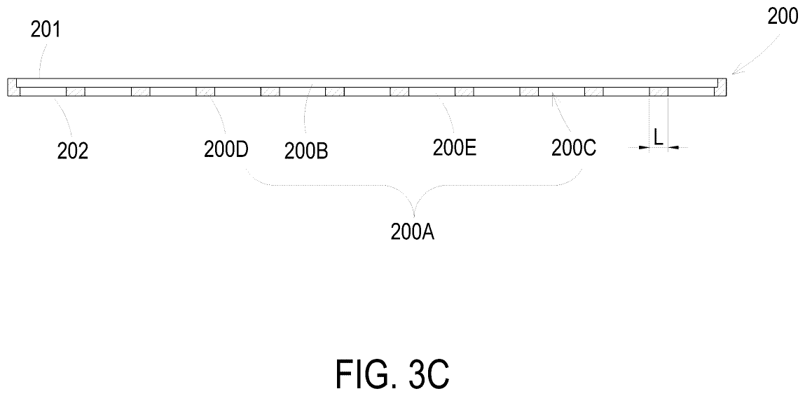

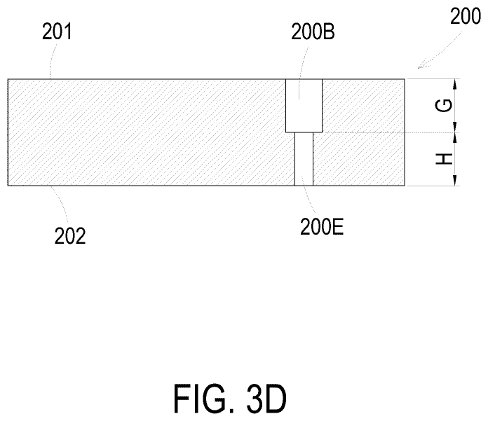

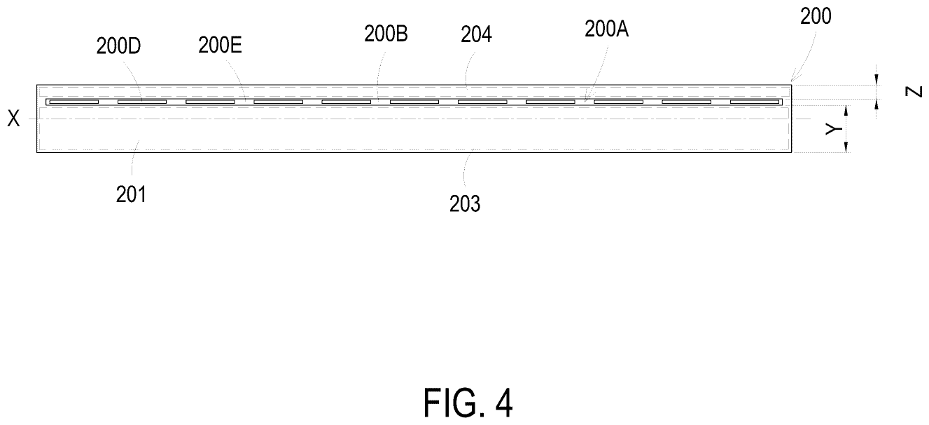

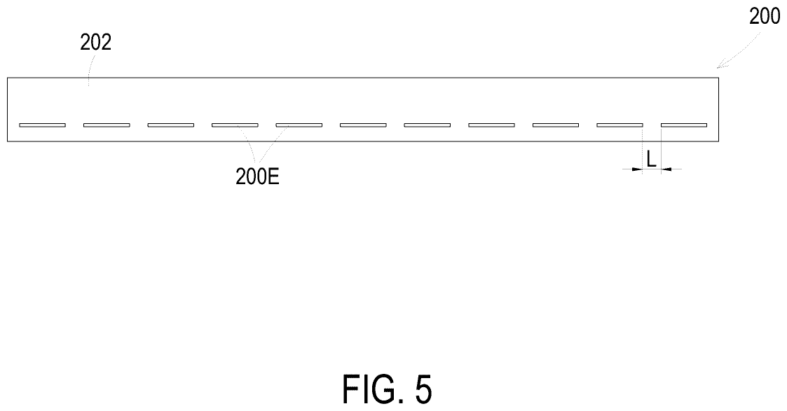

Please refer to FIG. 3A, FIG. 3B, FIG. 3C, FIG. 3D, FIG. 4 and FIG. 5. According to an embodiment of the present disclosure, the ink supply hole 200A includes a first hollow portion 200B and a second hollow portion 200C. The first hollow portion 200B is recessed from the first surface 201 toward the second surface 202. The second hollow portion 200C is concavely recessed from a bottom surface of the first hollow portion 220B and penetrates through the second surface 202. At least one connection rib 200D is disposed and extended transversely between two lateral walls of the second hollow portion 200C, and the second hollow portion 200C is divided by the at least one connection rib 200D to form more than two through holes 200E. In the embodiment, each adjacent two of the plurality of through holes 200E on the second surface 202 of the inkjet chip 200 have a spaced distance L (i.e., the thickness of connection rib 200D) greater than 30 μm. By adding at least one connection rib 200D to make the ink supply hole 200A as spaced hollows, the at least one connection rib 200D is used as a stress conduction path to increase the stress-bearing volume and the supporting force around the ink supply hole 200A, thereby improving the chip strength. It makes the inkjet chip 200 less likely to break during the production process, thereby improving the production yield.

In the embodiment, the first hollow portion 200B of the ink supply hole 200A has a depth G greater than 20 μm. The second hollow portion 200C has a depth H greater than 30 μm. The first hollow portion 200B is designed with a larger volume to accommodate more ink, providing sufficient ink reserve for large-scale printing. The second hollow portion 200C is divided by the at least one connection rib 200D to form more than two through holes 200E. The smaller and deeper through hole 200E allows the ink to flow faster. In that, the ink replenishing speed of the first hollow portion 200B can be increased, thereby achieving the purpose of increasing the printing range.

In the embodiment, the plurality of through holes 200E are located on the second surface 202. The plurality of through holes 200E occupy more than 2.5% of the area of the second surface 202. That is, the area of one through hole 200E×the number of through holes 200E/the area of the second surface 202≥2.5%. During inkjet printing, by increasing the area of the plurality of through holes 200E, sufficient ink can be provided to enter the first hollow portion 200B through each through hole 200E, so as to avoid insufficient ink supply during printing, resulting in interruption of ink supply and affecting the printing quality (such as partial image or text loss, deformation, etc.). Thus, the effect of stabilizing the printing quality is achieved.

Please refer to FIG. 3A, FIG. 3B, FIG. 3C, FIG. 3D, FIG. 4 and FIG. 5. According to an embodiment of the present disclosure, the ink supply hole 200A is located on the first surface 201 of the inkjet chip 200 in an asymmetrical arrangement (the position can be clearly compared with the center line X in FIG. 4). The inkjet chip 200 forms a chip circuit area 203 on one side of the ink supply hole 200A, and forms a non-circuit area 204 on the other side of the ink supply hole 200A corresponding to the chip circuit area 203. The distance between the ink supply hole 200A in the chip circuit area 203 and the edge of the inkjet chip 200 (the width Y of the chip circuit area 203) is greater than the distance between the ink supply hole 200A in the non-circuit area 204 and the other edge of the inkjet chip 200 (the width Z of the non-circuit area 204), and the width of the non-circuit area 204 is greater than 400 μm.

In the embodiment, the inkjet chip 200 has a circuit for controlling inkjet printing in the chip circuit area 203. When the printer performs nozzle cleaning and maintenance, the cleaning soft board enables the cleaning mechanism to move the scraper from right to left to scrape away the dirty or stagnant ink on the surface of the nozzle apertures 210. The scraper is moved to contact the inkjet chip 200, and a large contact force impact is generated first by the scraper. After continuous contact and displacement, the contact force will be weakened. Therefore, with the width of the chip circuit area 203 greater than the width of the non-circuit area 204, and the same length design, it allows the chip circuit area 203 to have a larger volume for setting more circuits, and have the smaller non-line area 204 for the scraper to contact and withstand the greater impact. In this way, the circuits can be arranged in a sufficient space while avoiding damage to the circuits due to impact, thereby increasing the service life of the inkjet chip 200.

According to an embodiment of the present disclosure, in the one single-row-nozzle structure, each longitudinally adjacent two of the plurality of nozzle apertures 210 have a spaced distance ranged from 40 μm to 45 μm. The advantage of such a configuration is that the upper and lower nozzle apertures 210 can more effectively control the printing of the same nozzle point, so that the pattern on the nozzle point is more detailed.

According to an embodiment of the present disclosure, in the one single-row-nozzle structure, the nozzle apertures 210 of the plurality of heater 205 longitudinally arranged have an arrangement distance ranged from 24000 μm to 26000 μm. Since the working distance of the nozzle aperture 210 is wider, the printable range of the inkjet chip 200 is also ranged from 24000 μm and 26000 μm, so that the printable range is increased effectively.

According to an embodiment of the present disclosure, in the one single-row-nozzle structure, the plurality of nozzle apertures 210 are arranged longitudinally, and the number of nozzle apertures 210 in one single row is more than 600. Notably, the number of nozzle apertures 210, the lateral distance of the ink supply holes 200A, and the printable range are examples merely. Those skilled in the art can make any substitution or modification according to application requirements after reading the descriptions of the present disclosure.

According to an embodiment of the present disclosure, in the one single-row-nozzle structure, each longitudinally adjacent two of the plurality of nozzle apertures 210 in one single row have a vertical distance ranged from 40 μm to 45 μm. Preferably but not exclusively, the single-row nozzle structure can be disposed on the left side, right side or both sides of the ink supply hole 200A according to the practical requirements.

According to an embodiment of the present disclosure, in the one single-row-nozzle structure, the ink supply hole 200A has a lateral distance (width) greater than 80 μm.

Please refer to FIG. 3A, FIG. 3B, FIG. 3C, FIG. 3D and FIG. 6. The ink flow is located in the ink supply hole 200A, and the ink flows from the ink supply hole 200A to the ink chamber 220 in parallel, so as to reduce the flow path of the ink during supply and increase the speed of the ink during supply. Preferably but not exclusively, in the embodiment, the inkjet chip structure 200 is allowed to print at a resolution (Dots Per Inch, the number of dots or ink drops per inch) ranged from 150 DPI to 48000 DPI.

In the embodiment of the present disclosure, the thermal barrier layer 270 is an insulation material formed on the chip substrate 280. Preferably but not exclusively, the material of the chip substrate 280 is a silicon wafer. The insulation material is one selected from the group consisting of field oxide (FOX), silicon dioxide (SiO₂), silicon nitride (Si₃N₄), phosphorus silicon glass (PSG) and a combination thereof.

In the embodiment of the present disclosure, the heating resistance layer 260 is a resistor material formed on the thermal barrier layer 270. The resistor material one selected from the group consisting of polycrystalline silicon, tantalum aluminide (TaAl), tantalum (Ta), tantalum nitride (TaN), tantalum disilicide (Si₂Ta), carbon (C), silicon carbide (SiC), indium tin oxide (ITO), zinc oxide (ZnO), cadmium sulfide (CdS), hafnium diboride (HfB₂), titanium tungsten (TiW) alloy, titanium nitride (TiN) and a combination thereof.

In the embodiment of the present disclosure, the conductive layer 250 is a conductive material, and the conductive material is one selected from the group consisting of aluminum (Al), aluminum-copper (AlCu) alloy, gold (Au), aluminum-silicon alloy (AlSi), palladium (Pd), palladium-silver alloy (PdAg), platinum (Pt), aluminum-silicon-copper (AlSiCu), niobium (Nb), vanadium (V), hafnium (Hf), titanium (Ti), zirconium (Zr), yttrium (Y) and a combination thereof.

In the embodiment of the present disclosure, the conductive layer 250 is formed on the heating resistance layer 260 at a position not corresponding to the nozzle apertures 210, a portion of the protective layer 240 is formed on the heating resistance layer 260, and the other portion of the protective layer 240 is formed on the conductive layer 250. At the same time, the protective layer 240 includes a second protective layer 240B stacked on a first protective layer 240A at the bottom, and a third protective layer 240C stacked on the second protective layer 240B (that is, the stacked order from bottom to top is the first protective layer 240A, the second protective layer 240B and the third protective layer 240C). Preferably but not exclusively, the first protective layer 240A is made of silicon nitride (Si₃N₄) material. The second protective layer 240B is made of a passivation material, and the passivation material is one selected from the group consisting of silicon nitride (Si₃N₄), silicon dioxide (SiO₂), titanium dioxide (TiO₂), hafnium dioxide (HfO₂), zirconium dioxide (ZrO₂), tantalum pentoxide (Ta₂O₅), rhenium heptoxide (Re₂O₇), niobium pentoxide (Nb₂O₅), uranium pentoxide (U₂O₅), tungsten trioxide (WO₃), silicon oxynitride (Si₄O₅N₃), silicon carbide (SiC) and a combination thereof. The third protective layer 240C is made of a metal material, and the metal material is one selected from the group consisting of tantalum (Ta), tantalum nitride (TaN), titanium nitride (TiN), tungsten nitride (TiW) and a combination thereof. In the embodiment, the number and the material of the protective layer 240 can be appropriately adjusted and modified according to the degree of corrosion of the ink on each material, the thermal stress on the entire inkjet chip 200 caused by the temperature change during the operation of the heating resistance layer 260, and the product life cycle required by the inkjet chip 200. Similarly, the first protective layer 240A, the second protective layer 240B, and the third protective layer 240C described in the present disclosure are only for illustration and are not intended to limit the scope of rights of the present disclosure. It is explained here in advance.

In the embodiment of the present disclosure, the barrier layer 290 is a polymer material formed on the protective layer 240, and the polymer material is one selected from the group consisting of polyimide and organic plastic material. In the embodiment, the ink chamber 220 is integrally formed in the barrier layer 290, and the bottom of the ink chamber 220 is connected to the protective layer 240. The nozzle aperture is formed on the top of the ink chamber 220, and the nozzle aperture 210 penetrates through the nozzle plate 230.

In the embodiment of the present disclosure, the ink supply hole 200A in the inkjet chip 200 may be used to correspond 1-6 colors. The ink supply hole 200A shown in FIG. 3 is one used to correspond one of them, which can provide single-color ink. Preferably but not exclusively, the single-color ink is one selected from the group consisting of cyan (C), magenta (M), yellow (Y) and black (K) inks. In other embodiments of the present disclosure, the ink supply hole 200A is used to correspond 6 colors, which can respectively provide six ink colors: black (K), cyan (C), magenta (M), yellow (Y), light cyan (LC) and light magenta (LM). Certainly, in another embodiment, the ink supply hole 200A is used to correspond four colors, and provide cyan (C), magenta (M), yellow (Y), and black (K) inks respectively. The number or colors of the ink supply holes 200A can be replaced or modified according to the practical requirements.

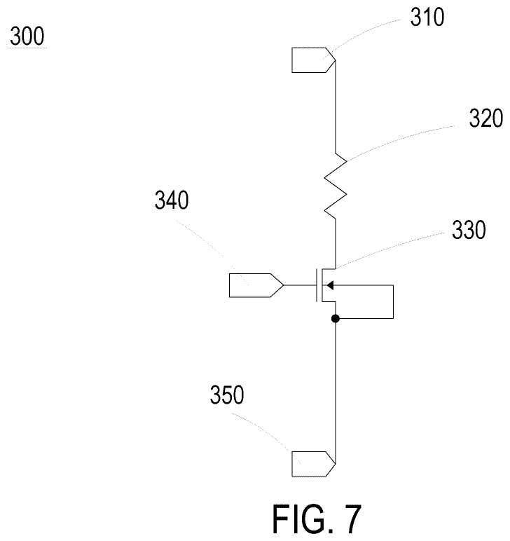

Please refer to FIG. 7. In the embodiment, the inkjet chip structure further includes a plurality of control modules 300 for controlling the operation of the nozzle apertures 210. The control module 300 includes a grounding unit 350, a power supply unit 310, a heating unit 320, a power control unit 330 and an addressing unit 340. The power supply unit 310 is configured to supply the power required for inkjet printing. The heating unit 320 is coupled to the power supply unit 310 to heat the ink required for inkjet printing. The power control unit 330 is coupled to the grounding unit 350 and capable of using the power of the power supply unit 310 to control the operation of the heating unit 320. The addressing unit 340 is configured to control the power control unit 330 to be turned on or off.

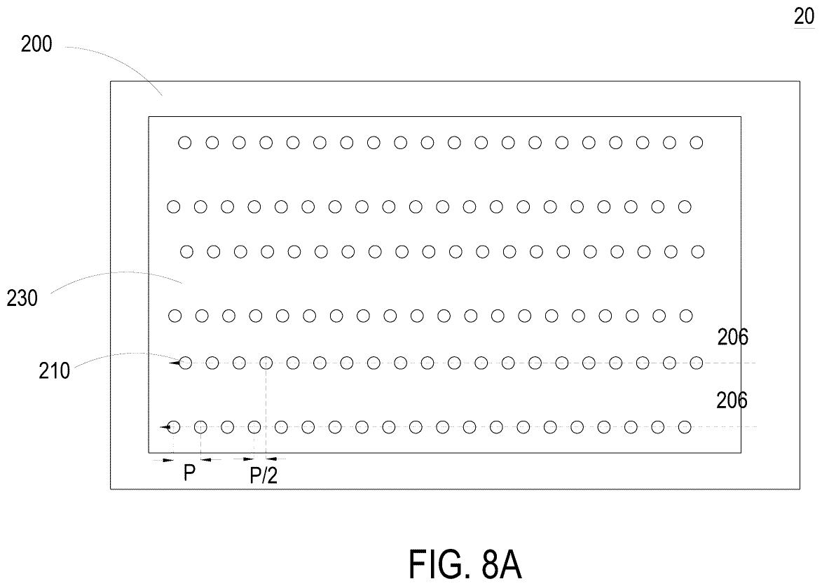

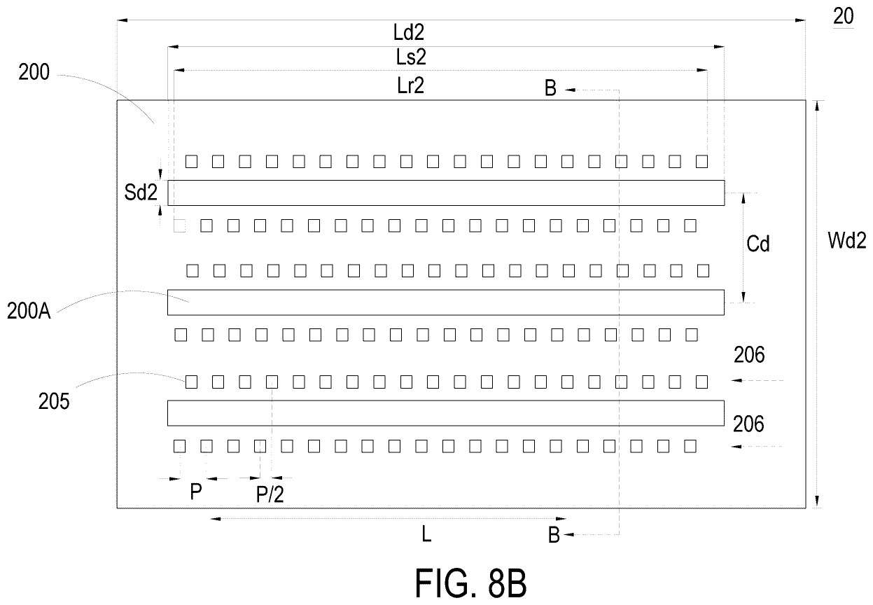

Please refer to FIG. 8A. It is a schematic diagram illustrating the inkjet chip structure for the color inkjet head. The inkjet head 20 shown in FIG. 8A is a simplified structural schematic diagram. In the embodiment, the inkjet head 20 is a long strip structure and includes an inkjet chip 200 and a nozzle plate 230. A plurality of heaters 205 (as shown in FIG. 8B) are disposed on the surface of the inkjet chip 200. The nozzle plate 230, which is the top layer of the heater 205, includes a plurality of nozzle apertures 210. Multi-channel color printing is mainly carried out by a certain printing resolution, and the dot pitch on the axis of the inkjet media can be less than or equal to the pitch of the axis nozzle apertures.

Please refer to FIG. 8A and FIG. 8B. FIG. 8B illustrates the inkjet chip structure with the heater 205 after the nozzle plate 230 on the top layer is removed in FIG. 8A. As shown in the figures, in the embodiment, the plurality of heaters 205 on the inkjet chip 200 of the inkjet head 20 are arranged in an array along the longitudinal axes 206 extended along a reference axis L, and are spaced apart from each other transversely or laterally relative to the reference axis L. In addition, the inkjet chip 200 includes three ink supply holes 200A parallel to the reference axis L, which are mainly used to provides ink droplets of different colors respectively. The three longitudinal axes 206 of the array are spaced apart from each other in a direction perpendicular to the reference axis L, so that the three ink supply holes 200A provides the ink droplets of different colors to the heaters 205 of the corresponding three longitudinal axes 206 of the array. In the embodiment, the plurality of heaters 205 arranged in the array along each of the three longitudinal axes 206 are divided into at least two axis groups of the same color, which are disposed on both sides of the ink supply hole 200A and parallel to the direction of the reference axis L. The at least two axis groups of heaters 205 are misaligned on both sides of the ink supply hole 200A. Therefore, the inkjet chip 200 of the embodiment has 2 axis groups×3 colors=6 rows of heaters.

In the embodiment, each of the three longitudinal axes 206 of the array may include 600 or more heaters 205. That is, there are 300 heaters 205 disposed on each row of heaters 205 on the axis group. Therefore, the total number of heaters 205 on the inkjet chip 200 is 1800. Each longitudinally adjacent two of heaters 205 in the same row of each longitudinal axis 206 have a distance P. Each longitudinally adjacent two of heaters 205 in different rows of longitudinal axes 206 have a vertical distance P/2. Preferably but not exclusively, in the embodiment, the distance P is 1/600 inch, and the distance P/2 may be 1/1200 inch.

In some embodiments, the distance P between two adjacent heaters 205 in the same row of each longitudinal axis 206 is ranged from 1/600 inch to 1/1200 inch, and the vertical distance P/2 between two adjacent heaters 205 in different rows of longitudinal axes 206 is ranged from 1/1200 inch to 1/2400 inch.

In the embodiment, the inkjet chip 200 of the inkjet head 20 has a rectangular structure, and an aspect ratio ranged from 3.6 to 9.0. Preferably but not exclusively, the width Wd2 of the inkjet chip 200 is approximately 4.5 millimeters (mm), the length Ld2 of the inkjet chip 200 is approximately 16 millimeters (mm), the total area of the inkjet chip 200 is 72 millimeters (mm), and the aspect ratio of the inkjet chip 200 is Ld2/Wd2=16/4.5=3.6. Preferably, the heaters 205 is disposed on the inkjet chip 200 at the density ranged from 20.1 to 30.0. The total length Lr2 of each row of heaters 205 is approximately ½ inch, and the total number of heaters 205 is approximately 1800. Therefore, the density of heaters 205 per square millimeter (mm²) on the inkjet chip 200 of the present disclosure is approximately 1800÷(16×4.5)=25.

Preferably but not exclusively, in the embodiment, the width Sd2 of each ink supply hole 200A is be 0.15 millimeters (mm), the length Ls2 of each ink supply hole 200A is 12.8 millimeters (mm), and the distance Cd between two adjacent ink supply holes 200A is 1.27 millimeters (mm). Therefore, the ratio of the total width of the three ink supply holes 200A to the B-B cross-sectional area of the inkjet chip 200 is: (Sd2/Wd2)×3=(0.15 mm/4.5 mm)×3=10%. Preferably but not exclusively, in other embodiments, the distance Cd between two adjacent ink supply holes 200A is 1.27 millimeters (mm), and the width Sd2 of each ink supply hole 200A is 0.17 mm. The width Sd2 of each ink supply hole 200A is ranged from 0.15 mm to 0.17 mm, and the length Ls2 of each ink supply hole 200A is ranged from 0.15 mm to 0.17 mm. The ratio of the total width of the three ink supply holes 200A to the B-B cross-sectional area of the inkjet chip 200 is ranged from 6.25% to 10%.

Preferably but not exclusively, in another embodiment, the inkjet chip 200 has 6 rows of heaters 205, and the total number of heaters 205 is ranged from 2000 to 3000. The width Wd2 of the inkjet chip 200 is ranged from 2.5 mm to 3.5 mm, the length Ld2 of the inkjet chip 200 is ranged from 12.7 mm to 25.4 mm, the total area of the inkjet chip 200 is ranged from 31.75 mm to 88.9 mm, the aspect ratio of the inkjet chip 200 is ranged from 3.6 to 10, and the density of the heaters 205 per square millimeter (mm²) on the inkjet chip 200 is ranged from 31 to 90. Preferably but not exclusively, the total length Lr2 of each row of heaters 205 is about ½ inch, and the density of heaters 205 per square millimeter (mm²) on the inkjet chip 200 is about (2000/88.9) to (3000/31.75), that is, 22.4 to 94.5. As for the above calculation of the density of the heaters 205 on the inkjet chip 200, the area of the ink supply holes 200A is also taken into account.

Preferably but not exclusively, in the embodiment, the heaters 205 are disposed on the inkjet chip 200 of inkjet head 20 in a misaligned arrangement to set more, so that the utilization space of the inkjet head 20 is improved, the cost is reduced, and the printing speed is increased. In addition, the chip area is further reduced by streamlining the address control method of the inkjet chip 200 inside the inkjet head 20, so that the size of the inkjet head 20 is relatively reduced, thereby reducing the cost of producing the inkjet printer.

Generally speaking, in order to keep the light-weight ink droplets printing at a high speed, the heaters 205 need to be operated at a very high frequency. The inkjet head 20 of the present disclosure provides high-resolution and high-speed printing by combining a high-jet frequency with a high-density misaligned arrangement of heaters 205. The jet frequency used by the heater 205 of the inkjet head 20 of the present disclosure exceeds 20 kHz. Preferably but not exclusively, the jet frequency is ranged from 22 kHz to 26 kHz. The heaters 205 of the embodiment are operated at a working frequency of 24 kHz.

From the above descriptions, the present disclosure provides an i nkjet chip structure. By adding at least one connection rib 200D to the second hollow portion 200C in the ink supply hole 200A of the inkjet chip 200, the second hollow portion 200C is divided by at least one connection rib 200D to form more than two through holes 200E. The at least one connection rib 200D is used as a stress conduction path to increase the stress-bearing volume and the supporting force around the ink supply hole 200A, thereby improving the chip strength. It makes the inkjet chip 200 less likely to break during the production process, thereby improving the production yield and meeting the increasingly stringent market demands. The present disclosure has great industrial applicability and meets the patent requirements, so as to be filed.

While the invention has been described in terms of what is presently considered to be the most practical and preferred embodiments, it is to be understood that the invention is not need to be limited to the disclosed embodiments. On the contrary, it is intended to cover various modifications and similar arrangements included within the spirit and scope of the appended claims so as to encompass all such modifications and similar structures.

What is claimed is:

1. An inkjet chip structure, comprising:
an inkjet chip comprising:
a first surface;
a second surface; and
three ink supply holes concavely formed on the first surface of the inkjet chip, penetrating through the second surface, and extended longitudinally, wherein each of the three ink supply holes comprises:
a first hollow portion, recessed from the first surface toward the second surface; and
a second hollow portion concavely recessed from a bottom surface of the first hollow portion and penetrating through the second surface, wherein at least one connection rib is disposed and extended transversely between two lateral walls of the second hollow portion, and the second hollow portion is divided by the at least one connection rib to form a plurality of through holes; and
a plurality of heaters connected to the three ink supply holes, and arranged in an array along three longitudinal axes, wherein the plurality of heaters arranged in the array along each of the three longitudinal axes provides ink droplets of different colors respectively, and there are at least 2000 heaters to 3000 heaters arranged in the array along three longitudinal axes.

2. The inkjet chip structure according to claim 1, wherein the heater comprises:
a chip substrate;
a heating resistance layer for heating an ink;
a conductive layer, supplying required energy to the heating resistance layer to heat the ink;
a protective layer;
a barrier layer;
a nozzle plate, wherein the chip substrate, the heating resistance layer, the conductive layer, the protective layer, the barrier layer and the nozzle plate are stacked sequentially to form a stacked structure; and
an ink chamber formed between the protective layer, the barrier layer and the nozzle plate, wherein a plurality of nozzle apertures penetrate the nozzle plate arranged on a top of the ink chamber.

3. The inkjet chip structure according to claim 1, wherein the first hollow portion has a depth greater than 20 μm.

4. The inkjet chip structure according to claim 1, wherein the second hollow portion has a depth greater than 30 μm.

5. The inkjet chip structure according to claim 1, wherein each adjacent two of the plurality of through holes on the second surface of the inkjet chip have a spaced distance greater than 30 μm.

6. The inkjet chip structure according to claim 2, wherein each longitudinally adjacent two of the plurality of nozzle apertures have a vertical distance ranged from 80 μm to 90 μm.

7. The inkjet chip structure according to claim 2, wherein each longitudinally adjacent two of the plurality of nozzle apertures have a vertical distance ranged from 40 μm to 45 μm.

8. The inkjet chip structure according to claim 2, wherein the plurality of nozzle apertures longitudinally arranged have an arrangement distance ranged from 24000 μm to 26000 μm.

9. The inkjet chip structure according to claim 1, wherein the ink supply hole has a lateral distance greater than 80 μm.

10. The inkjet chip structure according to claim 1, wherein the plurality of heaters arranged in the array along each of the three longitudinal axes are divided into at least two axis groups along axes which are parallel to each other and spaced apart from each other.

11. The inkjet chip structure according to claim 10, wherein the plurality of heaters included in each of the axis groups have a total length of is ½ inches.

12. The inkjet chip structure according to claim 1, wherein each of the three ink supply holes has a width of 0.15 mm and a length of 12.8 mm.

13. The inkjet chip structure according to claim 1, wherein the three ink supply holes have a spaced distance 12.7 mm.

14. The inkjet chip structure according to claim 1, wherein inkjet chip has an aspect ratio of 3.6.

15. The inkjet chip structure according to claim 1, wherein inkjet chip has an aspect ratio ranged from 4.0 to 9.0.

16. The inkjet chip structure according to claim 1, wherein the inkjet chip includes 1800 heaters disposed thereon.

17. The inkjet chip structure according to claim 1, wherein the plurality of heaters are disposed on the inkjet chip at the density ranged from 20.1 heaters per square millimeter (mm²) to 30.0 heaters per square millimeter (mm²).

18. The inkjet chip structure according to claim 1, wherein each adjacent two of the plurality of heaters have a spaced distance of 1/600 inch.
